(19) United States
(12) Patent Application Publication
(10) Pub. No.: US 2021/0276851 A1
(43) Pub. Date: Sep. 9, 2021

(54) Systems, Devices, and/or Methods for Managing Food Container Lids

(71) Applicant: John Olive, North Chesterfield, VA (US)

(72) Inventor: John Olive, North Chesterfield, VA (US)

(21) Appl. No.: 16/808,858

(22) Filed: Mar. 4, 2020

(51) Int. Cl. B67B 7/40

(52) U.S. Cl. CPC B67B 7/406

(57) ABSTRACT

Certain exemplary embodiments can provide a device comprising a jaw portion, a curved base, and a lifting tail. The jaw portion constructed to engage with a tab of a pull-tab can. When a user engages the jaw portion with the tab of the pull-tab can, the curved base is constructed to cause the pull-tab lift when the curved base is rotated on a surface of the pull-tab can. The lifting tail is constructed to, responsive to the user engaging the tail with the tab of the pull-tab can and rotating the curved base on the surface of the pull-tab can, fully open the pull-tab can.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a side view of an exemplary embodiment of a device 1000;

FIG. 2 is a bottom view of device 1000;

FIG. 3 is a perspective view of device 1000;

FIG. 4 is a perspective view of an exemplary embodiment of a system 4000;

FIG. 5 is a perspective view of system 4000;

FIG. 6 is a perspective view of system 4000;

FIG. 6B is a perspective view of system 4000;

FIG. 7 is a perspective view of system 4000;

FIG. 8 is a perspective view of system 4000;

FIG. 9 is a perspective view of system 4000; and

FIG. 10 is a perspective view of system 4000.

### DETAILED DESCRIPTION

Certain exemplary embodiments can provide a device comprising a jaw portion, a curved base, and a lifting tail. The jaw portion constructed to engage with a tab of a pull-tab can. When a user engages the jaw portion with the tab of the pull-tab can, the curved base is constructed to cause the pull-tab lift when the curved base is rotated on a surface of the pull-tab can. The lifting tail is constructed to, responsive to the user engaging the tail with the tab of the pull-tab can and rotating the curved base on the surface of the pull-tab can, fully open the pull-tab can.

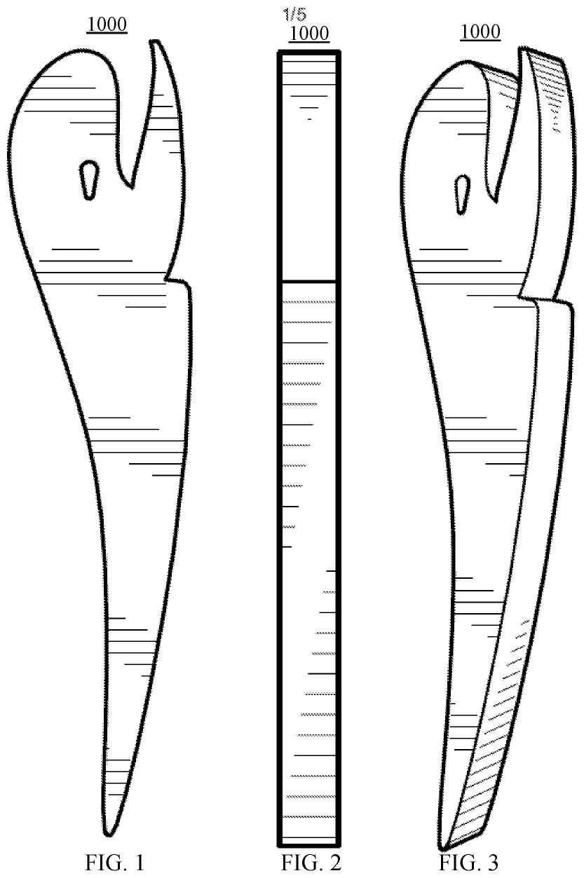

FIG. 1 is a side view of an exemplary embodiment of a device 1000.

FIG. 2 is a bottom view of device 1000.

FIG. 3 is a perspective view of device 1000.

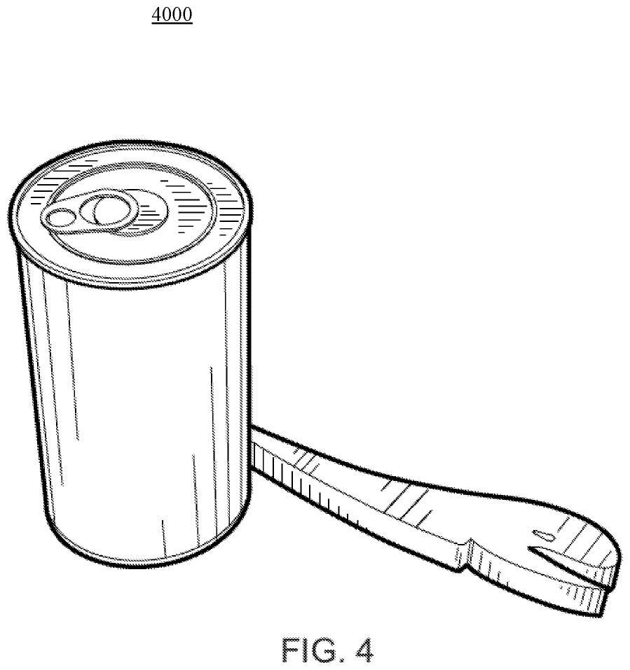

FIG. 4 is a perspective view of an exemplary embodiment of a system 4000.

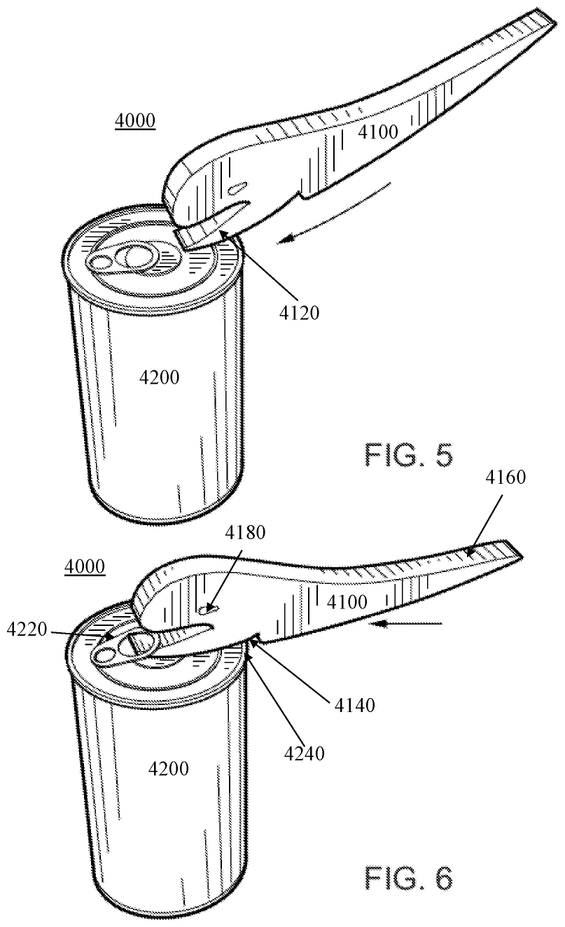

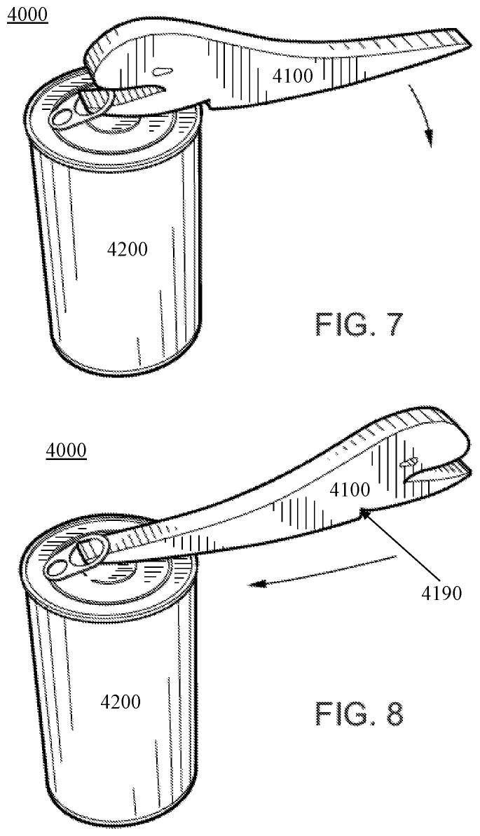

FIGS. 5-10 are perspective views of system 4000, which comprises a device 4100 and a pull-tab can 4200. Device 4100 comprises a jaw portion 4120, a curved base 4140, and a lifting tail 4160.

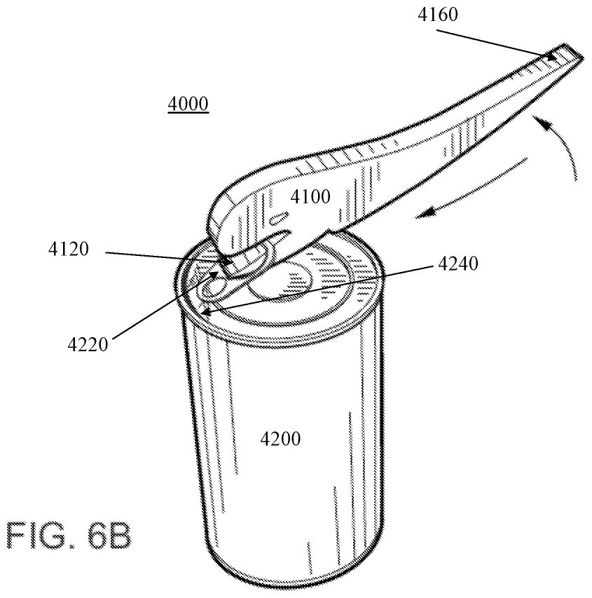

As illustrated in FIG. 6, jaw portion 4120 is constructed to engage with a tab 4220 of pull-tab can 4200. When a user engages jaw portion 4120 with tab 4220 of pull-tab can 4200, curved base 4140 is constructed to cause tab 4220 to lift when curved base 4140 is lifted via contact with a surface 4240 of pull-tab can 4200.

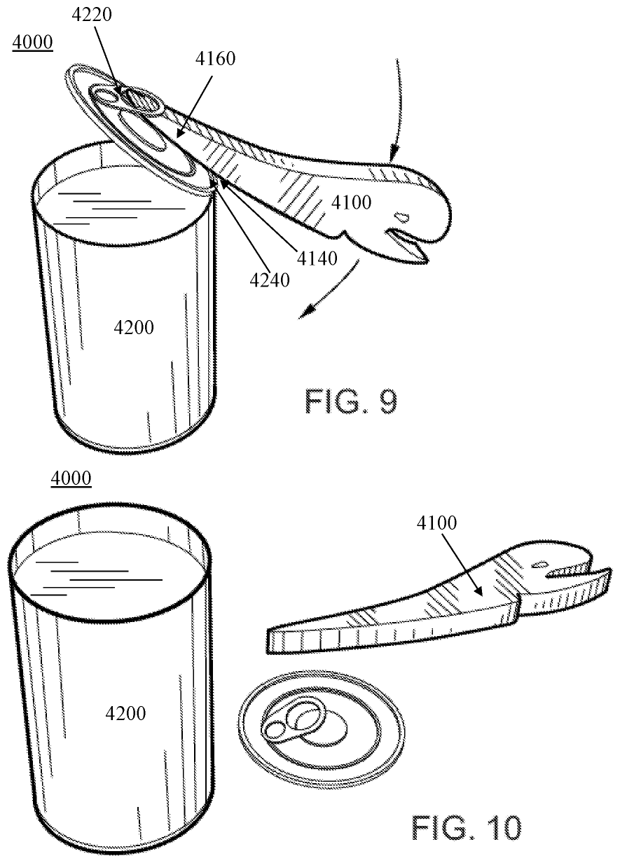

As illustrated in FIG. 9, lifting tail 4160 is constructed to, responsive to the user engaging lifting tail 4160 with tab 4220 of pull-tab can 4200 and rotating curved base 4140 on surface 4240 of pull-tab can 4200, fully open pull-tab can 4200 (see FIG. 9 and FIG. 10).

FIG. 6B is a perspective view of system 4000, which illustrates a potentially different method of using device 4100. As shown, jaw portion 4120 can be engaged with tab 4220 with the user holding device 4100 above pull-tab can 4200. The user lifts device 4100, which causes tab 4220 to be raised and to pierce an edge of top 4240 of pull-tab can 4200. After tab 4220 has been raised, the user turns device 4100 to engage lifting tail 4160 to fully open pull-tab can 4200 (see FIG. 9 and FIG. 10).

Device 4100 can defines an aperture 4180 (see FIG. 6), which aperture 4180 simulates an appearance of an eye of an animal (e.g., a whale). Device 4100 can define a notch 4190 (see FIG. 8), which notch 4190 simulates an appearance of a neck of an animal (e.g., a whale).

Certain exemplary embodiments can provide a method, which method can comprise causing a pull-tab can to be opened. The can is openable via a device comprising a jaw portion, a curved base, and a lifting tail. The jaw portion is constructed to engage with a tab of a pull-tab can. When a user engages the jaw portion with the tab of the pull-tab can, the curved base is constructed to cause the tab to lift when the curved base is rotated on a surface of the pull-tab can. The lifting tail is constructed to, responsive to the user engaging the lifting tail with the tab of the pull-tab can and rotating the curved base on the surface of the pull-tab can, fully open the pull-tab can.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between
different parts of one or more pieces of an apparatus or system.
and/or—either in conjunction with or in alternative to.
animal—any member of the kingdom Animalia, comprising multicellular organisms that have a well-defined shape and usually limited growth, can move voluntarily, actively acquire food and digest it internally, and have sensory and nervous systems that allow them to respond rapidly to stimuli.
aperture—an opening in something.
apparatus—an appliance or device for a particular purpose.
appearance—a way something looks.
associate—to join, connect together, and/or relate.
can—is capable of, in at least some embodiments.
cause—to produce an effect.
comprising—including but not limited to.
configure—to make suitable or fit for a specific use or situation.
connect—to join or fasten together.
constructed to—made to and/or designed to.
convert—to transform, adapt, and/or change.
coupleable—capable of being joined, connected, and/or linked together.
coupling—linking in some fashion.
create—to bring into being.
curved—defined by one or more curved lines.
define—to establish the outline, form, or structure of
device—a machine, manufacture, and/or collection thereof.
engage—to be in contact and interact with.
eye—a specialized light-sensitive sensory structure of animals.
install—to connect or set in position and prepare for use.
jaw—two opposing surfaces that are constructed to pry a pull tab.
lift—to move or bring something upward from the ground or other support to a higher position.
may—is allowed and/or permitted to, in at least some embodiments.
method—a process, procedure, and/or collection of related activities for accomplishing something.
neck—a relatively narrow part of an object that connects two other portions of an object.
notch—an indentation or incision on an edge or surface.
plurality—the state of being plural and/or more than one.
portion—a part of a whole.
predetermined—established in advance.
provide—to furnish, supply, give, and/or make available.
pull-tab can—a container that is openable via a ring or tab that is pullable to remove a lid of the container.
receive—to get as a signal, take, acquire, and/or obtain.
repeatedly—again and again; repetitively.
rotate—to move or cause to move around an axis or center.
select—to make a choice or selection from alternatives.
set—a related plurality.
simulate—to resemble something.
store—to place, hold, and/or retain.
substantially—to a great extent or degree.
support—to bear the weight of, especially from below.
surface—the outer boundary of an object or a material layer.
system—a collection of mechanisms, devices, machines, articles of manufacture, processes, data, and/or instructions, the collection designed to perform one or more specific functions.
tab—a small piece that is pulled in order to open a pull-tab can.
tail—a back, last, or lower part of something.
transmit—to send, provide, furnish, and/or supply.
user—a person that uses a device.
via—by way of and/or utilizing.
weight—the force with which a body is attracted toward Earth, equal to
the product of the object's mass and the acceleration of gravity.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A device comprising:
a jaw portion, the jaw portion constructed to engage with a tab of a pull-tab can;
a curved base, when a user engages the jaw portion with the tab of the pull-tab can, the curved base is constructed to cause the tab to lift when the curved base is rotated on a surface of the pull-tab can; and
a lifting tail, the lifting tail constructed to, responsive to the user engaging the lifting tail with the tab of the pull-tab can and rotating the curved base on the surface of the pull-tab can, fully open the pull-tab can.

2. The device of claim 1, wherein:
the device defines an aperture, the aperture simulating an appearance of an eye of an animal.

3. The device of claim 1, wherein:
the device defines a notch, the notch simulating an appearance of a neck of an animal.

4. A method comprising:
causing a pull-tab can to be opened via a device comprising:
a jaw portion, the jaw portion constructed to engage with a tab of a pull-tab can;
a curved base, when a user engages the jaw portion with the tab of the pull-tab can, the curved base is constructed to cause the tab to lift when the curved base is rotated on a surface of the pull-tab can; and
a lifting tail, the lifting tail constructed to, responsive to the user engaging the lifting tail with the tab of the pull-tab can and rotating the curved base on the surface of the pull-tab can, fully open the pull-tab can.
